(19) United States
(12) Patent Application Publication
(10) Pub. No.: US 2007/0154664 A1
(43) Pub. Date: Jul. 5, 2007

(54) Cargo tank coating

(75) Inventor: Guy Johnson, Worksop (GB)

Correspondence Address: LAUBSCHER & LAUBSCHER, P.C., 1160 SPA ROAD, SUITE 2B, ANNAPOLIS, MD, 21403, US

(73) Assignee: L&I MARITIME LIMITED, Worksop (GB)

(21) Appl. No.: 11/571,319

(22) PCT Filed: Mar. 31, 2005
(86) PCT No.: PCT/GB05/01304

§ 371 Date: Dec. 27, 2006

(30) Foreign Application Priority Data
Jun. 28, 2004 (GB) 0414404.4

(51) Int. Cl. B31B 45/00

(52) U.S. Cl. 428/34.1

(57) ABSTRACT

A water soluble barrier coating formulation for treating an interior surface of a cargo tank, the formulation comprising a solvent and a rheological additive configured to increase the viscosity of the solvent to allow the substantially liquid formulation to adhere to the interior surface and not drain away under gravity. The formulation is configured to inhibit absorption of a liquid cargo and in particular a hydrocarbon based cargo at the inner surface of the cargo tank so as to eliminate the requirement for detergents and aggressive solvents in order to clean the interior surface following cargo transportation. The time required to clean the cargo tanks is also reduced. The formulation is configured to be sprayed onto the interior surface and simply removed by washing with excess water, in particular hot water

### FIELD OF THE INVENTION

The present invention relates to a barrier coating formulation coated onto the interior surface of a cargo tank and in particular, although not exclusively, to a water soluble barrier coating configured to form a preventive coating on the interior surface of the cargo tank.

### BACKGROUND TO THE INVENTION

Cargo tankers are used to transport a variety of different cargoes by sea. Commonly, the cargo is in liquid form being stored within large cargo tanks located within the vessel body.

It is possible to divide these cargo tanks into three separate categories based on the type of coating formed on the interior surface of the tank or the type of material from which the tank is manufactured. A known and first type of tank is manufactured from stainless steel, a second type is coated with an organic based coating (e.g. a phenolic based epoxy or polyurethane epoxy) and a third type is coated with an inorganic based coating which is commonly zinc silicate.

Cargo vessels are typically required to transport a variety of different liquid cargoes ranging from specialist chemicals to crude hydrocarbon based oils. It is therefore required to thorough clean the interior of the cargo tanks between transportations of different cargos to ensure the liquid cargo is not contaminated by residual amounts of the previous cargo.

Detergents and solvents, in particular, methanol, ethanol and ketones are commonly used to thoroughly clean the interior surfaces. As will be appreciated, a certain amount of cargo penetrates the interior surface of the cargo tank during storage particularly in the case of the organic and inorganic coatings. The problem of cargo penetration and adsorption at the tank surface necessitates extensive cleaning of the internal surface with aggressive detergents and solvents, particularly where the storage and transportion of hydrocarbon oils is concerned.

Moreover, the interior surfaces of zinc silicate coated cargo tanks are typically profiled, whereby hydrocarbons are captured and trapped within micro cavities formed within the coating. These trapped hydrocarbons are not readily removed with detergents and solvents. There are many problems associated with the use of detergents and solvents for the large scale cleaning of cargo tanks including for example hazardous working conditions for personnel cleaning the tanks, and storage and disposal of the cleaning products before and after use.

A further problem exists with conventional cleaning techniques due to the incomplete removal of cargo from the interior surfaces particularly where hydrocarbon based cargoes have been transported. Incomplete cargo removal results in both subsequent cargo contamination and significant delays in transportation resulting from extended cleaning operations. What is required therefore is apparatus and method to solve the above problems.

### SUMMARY OF THE INVENTION

A barrier coating formulation is provided configured as a preventive coating for the interior surface of a cargo tank whereby hydrocarbon based cargoes are prevented from adhering to the interior surface during and after transportation. The interior surfaces of the cargo tanks, coated with the formulation according to the present invention, require considerably less time intensive cleaning operations when compared to untreated tanks. Moreover, the requirement for strong detergents and aggressive solvents, as part of the cleaning operation is avoided.

The preventive coating is water soluble and may be removed from the interior surface by rinsing with water, in particular hot water. Moreover, the formulation according to a specific implementation of the present invention comprises naturally occurring compounds and therefore provides numerous environmental advantages.

According to a first aspect of the present invention there is provided a cargo tank comprising a water soluble barrier coating formulation coated onto an interior surface of a cargo tank, said formulation comprising: a solvent; and a rheological additive configured to increase the viscosity of said solvent; wherein said formulation comprises a viscosity configured to provide temporary adhesion of said formulation to said interior surface of said cargo tank said formulation capable of being removed from said cargo tank by rinsing said interior surface with water.

According to a second aspect of the present invention there is provided method of coating an interior surface of a cargo tank with a water soluble barrier coating formulation comprising: mixing a solvent with a Theological additive configured to increase the viscosity of said solvent; and spraying said formulation onto said interior surface of said cargo tank; wherein said formulation is sufficiently viscous for the temporary adhesion of said formulation to said interior surface of said cargo tank.

According to a third aspect of the present invention there is provided a method of preventing hydrocarbons from adhering to an interior surface of a cargo tank comprising: mixing a solvent comprising at least one hydroxyl group with a rheological additive configured to increase the viscosity of said solvent; and coating said interior surface of said cargo tank with the solvent and rheological additive mixture; storing a hydrocarbon based liquid within said cargo tank; removing said hydrocarbon based liquid from said tank; and removing said solvent and rheological additive mixture from said interior surface by washing said interior surface with water; wherein hydrocarbons of said hydrocarbon based liquid are inhibited and preferably prevented from adhering to the interior surface of said cargo tank after coating said interior surface of said cargo tank with said solvent and rheological additive mixture.

According to a fourth aspect of the present invention there is provided a cargo tank comprising a water soluble barrier coating formulation coated onto an interior surface of said cargo tank said formulation comprising: glycerol or a glycerol derivative; and a natural gum configured to increase the viscosity of said glycerol or said glycerol derivative.

According to a fifth aspect of the present invention there is provided a cargo tank comprising a substantially liquid formulation coated onto an interior surface of a cargo tank, said formulation configured to prevent a hydrocarbon stored within said cargo tank adhering to said interior surface, said formulation comprising: a water soluble solvent; and a water soluble rheological additive configured to increase the viscosity of said solvent; wherein said substantially liquid formulation comprises a viscosity configured to provide temporary adhesion of said formulation to said interior surface of said cargo tank during storage of is said hydrocarbon within said cargo tank, said formulation capable of being removed from said cargo tank by rinsing said interior surface with water.

### DETAILED DESCRIPTION

There will now be described by way of example a specific mode contemplated by the inventors. In the following description numerous specific details are set forth in order to provide a thorough understanding. It will be apparent however, to one skilled in the art, that the present invention may be practiced without limitation to these specific details. In other instances, well known methods and structures have not been described in detail so as not to unnecessarily obscure the description.

The inventors provide a water soluble barrier coating formulation and a method of coating an interior surface of a cargo tank with a formulation so as to considerably inhibit a hydrocarbon or hydrocarbon based cargo penetrating and adhering to the interior surface of a cargo tank.

The preventative coating comprising the rheological additive, is sufficiently viscous whereby during application of the formulation in the liquid phase it is configured to adhere to the cargo tank surface and not drain away under gravity. Once applied, the formulation is configured to dry forming a substantially solid barrier coating.

The formulation is particularly advantageous for coating zinc silicate cargo tank surfaces in that micro cavities or pores formed within the zinc silicate may be filled or blocked by the formulation during application in the liquid phase and subsequent drying to form a solid coating. The zinc silicate coating is thereby not exposed to the cargo during storage and transportation.

As the water soluble formulation is substantially insoluble in hydrocarbon oils the formulation is particularly advantageous as a barrier coating for the transportation of hydrocarbons and hydrocarbon based oils.

Formulations

The following examples include different alternative barrier coating formulations configured to be particularly suitable as prevented coatings for the interior surfaces of cargo tanks. In particular, the examples detailed herein may be utilised with a variety of different cargo tank types including, for example, stainless steel cargo tanks, zinc silicate coated cargo tanks and cargo tanks initially coated with organic and/or inorganic paints.

Accordingly, the present invention is not restricted to anyone of the following examples and in particular may include combinations of different examples.

### EXAMPLE 1

A barrier coating formulation comprising water and one or more natural gum selected from the list of:

carrageenan gum;

xanthan gum;

arabic gum;

tragacanth gum;

guar gum;

caroube gum;

pectin.

### EXAMPLE 2

A water soluble barrier coating formulation comprising water and one or a combination of cellulosics selected from the list of:

carboxmethyl cellulose (CMC);

hydroxyethyl cellulose (HEC);

hydrophobically modified (HEC);

methyl cellulose (MC);

methyl hydroxyethyl cellulose (MHEC);

methyl hydroxpropyl cellulose (MHPC);

ethyl hydroxyethyl cellulose (EHEC);

hydrophobically modified (EHEC) or (HM-EHEC).

### EXAMPLE 3

A water soluble barrier coating formulation comprising water and anyone or a combination of organoclays selected from the list of:

bentonite;

hectorite.

### EXAMPLE 4

A water soluble barrier coating formulation comprising water and a gellant, in particular gelatine.

### EXAMPLE 5

A water soluble barrier coating formulation comprising water and one or a combination of associative synthetics selected from the list of:

an aqueous swellable emulsion (HASIE);

a polyurethane based thickener (HEUR);

a hydrophobically modified polyether.

### EXAMPLE 6

A water soluble barrier coating formulation comprising water and polyvinylalcohol.

### EXAMPLE 7

A water soluble barrier coating formulation comprising water and starch or a starch derivative.

### EXAMPLE 8

A water soluble barrier coating formulation comprising glycerol or a glycerol derivative and one or more natural gum selected from the list of:

carrageenan gum;

xanthan gum;

arabic gum;

tragacanth gum;

guar gum;

caroube gum;

pectin.

### EXAMPLE 9

A water soluble barrier coating formulation comprising glycerol or a glycerol derivative, in particular monoethylene glycol, and one or a combination of cellulosics selected from the list of:

carboxmethyl cellulose (CMC);

hydroxyethyl cellulose (HEC);

hydrophobically modified (HEC);

methyl cellulose (MC);

methyl hydroxyethyl cellulose (MHEC);

methyl hydroxpropyl cellulose (MHPC);

ethyl hydroxyethyl cellulose (EHEC);

hydrophobically modified (EHEC) or (HM-EHEC).

### EXAMPLE 10

A water soluble barrier coating formulation comprising glycerol or a glycerol derivative, and anyone or a combination of organoclays selected from the list of:

bentonite;

hectorite.

### EXAMPLE 11

A water soluble barrier coating formulation comprising glycerol or a glycerol derivative, and a gellant, in particular gelatin.

### EXAMPLE 12

A water soluble barrier coating formulation comprising glycerol or a glycerol derivative, and one or a combination of associative synthetics selected from the list of:

an aqueous swellable emulsion (HASIE);

a polyurethane based thickener (HEUR);

a hydrophobically modified polyether.

### EXAMPLE 13

A water soluble barrier coating formulation comprising glycerol or a glycerol derivative, and polyvinylalcohol.

### EXAMPLE 14

A water soluble barrier coating formulation comprising glycerol or a glycerol derivative and starch or a starch derivative.

### EXAMPLE 15

A water soluble barrier coating formulation comprises glycerol or a glycerol derivative, pectin and xanthan gum.

### EXAMPLE 16

A water soluble barrier coating formulation comprising glycerol or a glycerol derivative, polyvinylalcohol and xanthan gum.

### EXAMPLE 17

A water soluble barrier coating formulation comprising glycerol or a glycerol derivative, carrageenan gum and xanthan gum.

### EXAMPLE 18

A water soluble barrier coating formulation comprising glycerol or a glycerol derivative, gelatin and xanthan gum.

Cargo Tank Coating

### EXAMPLE 1

The water, glycerol or glycerol derivative solvent is firstly mixed with the rheological additive in sufficient proportions whereby the viscosity of the resulting mixture is sufficient to provide temporary adhesion of the formulation to the interior surface of the cargo tank during a drying process such that the liquid formulation is inhibited from draining away under gravity. The interior surface of the cargo tank may comprise stainless steel, an organic based paint or an inorganic coating being, in particular, zinc silicate. The formulation is then sprayed onto the interior surface using a mechanical spray device being a motorised spray apparatus for example a fuel or pneumatically driven device.

The viscosity of the substantially liquid formulation comprises a viscosity suitable to enable the formulation to be sprayed onto the interior surface of the cargo tank. In particular, the viscosity may be tailored by variation of the chosen rheological additive, the amount of rheological additive and/or the combinations of rheological additives included within the formulation. Moreover, the temperature of the formulation may be selectively adjusted during application onto the interior surface of the tank in order to optimise coverage of the surface whilst ensuring the formulation does not drain away under gravity once applied.

According to the specific implementations of the present invention the viscosity of the liquid phase formulation may be either proportional or inversely proportional to temperature.

Depending upon the type of cargo tank surface to be coated, the pH of the formulation may be tailored by variation of the rheological additive, with regard to compound, quantity, combinations thereof and/or temperature, in order to optimise the physical properties of the coating to successfully inhibit contact and penetration of the cargo into the cargo tank surface. In particular, the formulation may comprise a pH within the range 5 to 9 and/or or may be selectively adjusted by the addition of further reagents to sit within this range. Additionally, the formulation may be configured with a pH of 3.

After the internal surface is coated with the formulation, cargo is introduced into the cargo tank wherein it is temporarily stored during transportation. Following transportation, the cargo is removed from the cargo tank. To remove residual cargo from the interior surface in addition to removal of the preventative water soluble barrier coating formulation, the interior surface is washed with water, in particular hot water. The interior surface is then dried before a replacement barrier coating formulation is introduced onto the interior surface in preparation for transportation of a subsequent cargo.

### EXAMPLE 2

According to a further specific implementation of coating the interior surface of the cargo tank with the barrier coating formulation as illustrated under example 1 immediately above, the formulation may be sprayed onto the interior surfaces by a manual spraying action, for example through the use of a lance spray.

### EXAMPLE 3

According to a further specific implementation of coating the interior surface of the cargo tank, application of the coating may also be implemented using a fixed or portable tank cleaning machine commonly house within the cargo vessel. The formulation may be applied to the tank surface using the tank cleaning machines via a means of injection or recirculation of the formulation through the vessel's deepwell pump system. As will be appreciated by those skilled in the art, the deepwell pump is configured to pump and remove liquid from the cargo tanks.

According to further specific implementations the barrier coating formulation may be applied to the interior surface using any manor of coating application methods involving the use of brushes, rollers, pads, piping or hoses.

1. A cargo tank comprising a water soluble barrier coating formulation coated onto an interior surface of said cargo tank, said formulation comprising:
a solvent; and
a rheological additive configured to increase the viscosity of said solvent;
wherein said formulation comprises a viscosity configured to provide temporary adhesion of said formulation to said interior surface of said cargo tank, said formulation capable of being removed from said cargo tank by rinsing said interior surface with water.

2. The cargo tank as claimed in claim 1 wherein said rheological additive is a natural gum comprising any one or a combination of the following set of:
carrageenan gum;
xanthan gum;
arabic gum;
tragacanth gum;
guar gum;
caroube gum;
pectin.

3. The cargo tank as claimed in claim 1 wherein in said rheological additive is cellulose or a cellulose derivative comprising any one or a combination of the following set of:
carboxmethyl cellulose (CMC);
hydroxyethyl cellulose (HEC);
hydrophobically modified (HEC);
methyl cellulose (MC);
methyl hydroxyethyl cellulose (MHEC);
methyl hydroxpropyl cellulose (MHPC);
ethyl hydroxyethyl cellulose (EHEC);
hydrophobically modified (EHEC) or (HM-EHEC).

4. The cargo tank as claimed in claim 1 wherein said rheological additive is an organoclay comprising any one or a selection of the following set of:
bentonite;
hectorite.

5. The cargo tank as claimed in claim 1 wherein said rheological additive is a gellant, in particular gelatine.

6. The cargo tank as claimed in claim 1 wherein said rheological additive is a starch derivative.

7. The cargo tank as claimed in claim 1 wherein said rheological additive is an associative synthetic comprising any one or a selection of the following set of:
an aqueous swellable emulsion (HASE);
a polyurethane based thickener (HEUR);
a hydrophobically modified polyether.

8. The cargo tank as claimed in claim 1 wherein said rheological additive is polyvinylalcohol.

9. The cargo tank as claimed in any preceding claim wherein said solvent is water.

10. The cargo tank as claimed in any one of claims 1 to 8 wherein said solvent is glycerol or a glycerol derivative, in particular monoethylene glycol.

11. The cargo tank as claimed in claim 1 wherein said solvent is glycerol and said rheological additive comprises any one or a selection of the following set of:
pectin;
polyvinylalcohol;
carrageenan gum;
gelatine.

12. The cargo tank as claimed in claim 11 wherein said formulation further comprises xanthan gum.

13. The cargo tank as claimed in any preceding claim wherein said cargo tank comprises zinc silicate coated onto said interior surface, said formulation configured for the temporary addesion to said zinc silicate coated interior surface.

14. The cargo tank as claimed in any one of claims 1 to 12 comprising a stainless steel interior surface, said formulation configured for the temporary adhesion to said stainless steel interior surface.

15. The cargo tank as claimed in any one of claims 1 to 12 comprising an organic based paint coated onto said interior surface, said formulation configured for the temporary adhesion to said organic based paint.

16. The cargo tank as claimed in any preceding claim wherein said formulation comprises a pH within the range 5 to 9.

17. The cargo tank as claimed in claim 14 wherein said formulation comprises a pH of 3.

18. A method of coating an interior surface of a cargo tank with a water soluble barrier coating formulation comprising:
mixing a solvent with a rheological additive configured to increase the viscosity of said solvent; and
spraying said formulation onto said interior surface of said cargo tank;
wherein said formulation is sufficiently viscous for the temporary adhesion of said formulation to said interior surface of said cargo tank.

19. The method as claimed in claim 18 further comprising the step of storing a hydrocarbon within said cargo tank.

20. The method as claimed in claim 19 further comprising:
removing said hydrocarbon from said tank; and
removing said liquid formulation from said interior surface of said cargo tank by washing said interior surface with water.

21. The method as claimed in any one of claims 18 to 20 wherein said solvent comprises glycerol and said rheological additive comprises carrageenan gum.

22. The method as claimed in any one of claims 18 to 20 wherein said solvent is water.

23. The method as claimed in any one of claims 18 to 20 wherein said solvent is glycerol or a glycerol derivative.

24. The method as claimed in claims 22 or 23 wherein said rheological additive is a natural gum comprising any one or a combination of the following set of:
carrageenan gum;
xanthan gum;
arabic gum;
tragacanth gum;
guar gum;
caroube gum;
pectin.

25. The method as claimed in claims 22 and 23 wherein said rheological additive is cellulose or a cellulose derivative comprising any one or a combination of the following set of:
carboxmethyl cellulose (CMC);
hydroxyethyl cellulose (HEC);
hydrophobically modified (HEC);
methyl cellulose (MC);
methyl hydroxyethyl cellulose (MHEC);
methyl hydroxpropyl cellulose (MHPC);
ethyl hydroxyethyl cellulose (EHEC);
hydrophobically modified (EHEC) or (HM-EHEC).

26. The method as claimed in claims 22 or 23 wherein said rheological additive is an organoclay comprising any one or a selection of the following set of:
bentonite;
hectorite.

27. The method as claimed in claims 22 or 23 wherein said rheological additive is an associative synthetic comprising any one or a selection of the following set of:
an aqueous swellable emulsion (HASIE);
a polyurethane based thickener (HEUR);
a hydrophobically modified polyether.

28. The method as claimed in claims 22 or 28 wherein said rheological additive is a gellant, in particular gelatin.

29. The method as claimed in claims 22 or 23 wherein said rheological additive is polyvinylalcohol.

30. The method as claimed in any one of claims 18 to 29 wherein said interior surface of said cargo tank is a zinc silicate interior surface.

31. The method as claimed in claim 30 further comprising the step of tailoring a pH of said formulation to be between 5 and 9.

32. The method as claimed in any one of claims 18 to 31 wherein said step of a spraying said formulation onto said interior surface comprises the use of mechanical spray means and/or in particular pneumatically driven spray means.

33. The method as claimed in any one of claims 18 to 31 wherein said step of spraying said formulation onto said interior surface comprises the use of a fixed and/or portable tank cleaning machine housed within a cargo vessel, the application of said formulation onto said surface comprising injection or recirculation of said formulation through a deepwell pump system housed within said cargo vessel.

34. The method as claimed in any one of claims 18 to 31 wherein said step of spraying said formulation onto said interior surface comprises manually spraying said formulation using a spray lance.

35. A method of preventing hydrocarbons from adhering to an interior surface of a cargo tank comprising:
mixing a solvent comprising at least one hydroxyl group with a rheological additive configured to increase the viscosity of said solvent;
coating said interior surface of said cargo tank with the solvent and rheological additive mixture;
storing a hydrocarbon based liquid within said cargo tank;
removing said hydrocarbon based liquid from said tank; and
removing said solvent and rheological additive mixture from said interior surface by washing said interior surface with water;
wherein hydrocarbons of said hydrocarbon based liquid are prevented from adhering to the interior surface of said cargo tank after coating said interior surface of said cargo tank with said solvent and rheological additive mixture.

36. The method as claimed in claim 35 wherein said solvent is glycerol or a glycerol derivative and said rheological additive is carrageenan gum.

37. The method as claimed in claims 35 or 36 wherein said interior surface of said cargo tank comprises a zinc silicate coating.

38. The method as claimed in claim 35 wherein said solvent is water.

39. The method as claimed in claim 35 wherein said solvent is a glycerol or a glycerol derivative.

40. The method as claimed in claims 38 or 39 wherein said rheological additive is a natural gum comprising any one or a combination of the following set of:
carrageenan gum;
xanthan gum;
arabic gum;
tragacanth gum;
guar gum;
caroube gum;
pectin.

41. The method as claimed in claims 38 or 39 wherein said rheological additive is cellulose or a cellulose derivative comprising any one or a combination of the following set of:
carboxmethyl cellulose (CMC);
hydroxyethyl cellulose (HEC);
hydrophobically modified (HEC);
methyl cellulose (MC);
methyl hydroxyethyl cellulose (MHEC);
methyl hydroxpropyl cellulose (MHPC);
ethyl hydroxyethyl cellulose (EHEC);
hydrophobically modified (EHEC) or (HM-EHEC).

42. The method as claimed in 38 and 39 wherein said rheological additive is an organoclay comprising any one or a selection of the following set of:
bentonite;
hectorite

43. The method as claimed in claims 38 or 39 wherein said rheological additive is an associative synthetic comprising any one or a selection of the following set of:
an aqueous swellable emulsion (HASIE);
a polyurethane based thickener (HEUR);
a hydrophobically modified polyether.

44. The method as claimed in claims 38 or 39 wherein said rheological additive is a gellant, in particular gelatin.

45. The method as claimed in claims 38 or 39 wherein said rheological additive is polyvinylalcohol.

46. The method as claimed in any one of claims 35 to 45 wherein the solvent and rheological additive mixture maintains a substantially liquid phase during a coating of said interior surface.

47. A cargo tank comprising a water soluble barrier coating formulation coated into an interior surface of said cargo tank, said formulation comprising:
glycerol or a glycerol derivative; and
a natural gum configured to increase the viscosity of said glycerol or said glycerol derivative.

48. A cargo tank comprising a substantially liquid formulation coated onto an interior surface of said cargo tank, said formulation being configured to prevent a hydrocarbon stored within said cargo tank adhering to said interior surface, said formulation comprising:
a water soluble solvent; and
a water soluble rheological additive configured to increase the viscosity of said solvent;
wherein said substantially liquid formulation comprises a viscosity configured to provide temporary adhesion of said formulation to said interior surface of said cargo tank during storage of said hydrocarbon within said cargo tank, said formulation capable of being removed from said cargo tank by rinsing said interior surface with water.

49. The cargo tank as claimed in claim 48 wherein said solvent is water, glycerol or a glycerol derivative.

50. The cargo tank as claimed in claim 49 wherein said rheological additive comprises at least one natural gum.

51. The cargo tank as claimed in claim 49 wherein said rheological additive comprises at least one cellulosic.

52. The cargo tank as claimed in any one of claims 48 to 51 wherein said interior surface comprises zinc silicate.
